(19) United States
(12) Patent Application Publication
(10) Pub. No.: US 2006/0169497 A1
(43) Pub. Date: Aug. 3, 2006

(54) Weight sorter

(76) Inventor: Hsiu-An Chang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/048,030

(22) Filed: Feb. 1, 2005

(51) Int. Cl. G01G 19/00

(52) U.S. Cl. 177/145

(57) ABSTRACT

A weight sorter includes a base, a weight measuring device mounted on a top of the base to measure a weight of an article, and a pivot device mounted on a bottom of the base and operable to pivot the base when the weight measuring device measures the weight of the article so as to drop the article onto a predetermined conveyor belt. Thus, the pivot device does not apply any pressure or force on the weight measuring device during the pivot action, so that the weight measuring device is not subjected to an excessive force and can be used during a long-term utilization, thereby enhancing the lifetime of the weight measuring device 1.

### BACKGROUND OF THE INVENTION

1. Field of the Invention

The present invention relates to a weight sorter, and more particularly to a weight sorter having an enhanced lifetime.

2. Description of the Related Art

A conventional weight sorter comprises a weight measuring device mounted to measure the weight of an article, and a drive lever mounted on the weight measuring device to drive and pivot the weight measuring device. Thus, the drive lever is operable to pivot the weight measuring device when the weight measuring device measures the weight of the article so as to drop the article supported by the weight measuring device onto a predetermined conveyor belt, thereby finishing a weight selection work. However, the drive lever is suspended from the weight measuring device, so that a gap is defined between the drive lever and the weight measuring device, thereby incurring a jamming problem. In addition, the drive lever applies an excessive load onto the weight measuring device via the article, thereby greatly increasing the burden of measuring device, thereby decreasing the lifetime of measuring device during a long-term utilization.

### SUMMARY OF THE INVENTION

In accordance with the present invention, there is provided a weight sorter, comprising a base; a weight measuring device mounted on a top of the base to measure a weight of an article; and a pivot device mounted on a bottom of the base and operable to pivot the base when the weight measuring device measures the weight of the article so as to drop the article onto a predetermined conveyor belt, thereby finishing a weight selection work.

The primary objective of the present invention is to provide a weight sorter, wherein the pivot device does not apply any pressure or force on the weight measuring device during the pivot action, so that the weight measuring device is not subjected to an excessive force and can be used during a long-term utilization, thereby enhancing the lifetime of the weight measuring device.

Another objective of the present invention is to provide a weight sorter, wherein the ranges of the volume and weight of the article are not limited by provision of the pivot device, thereby enhancing the versatility of the weight sorter.

A further objective of the present invention is to provide a weight sorter, wherein after the weight measuring device measures the weight of the article, the weight measuring device stops operating until the pivot device is restored to its original state after dropping the article onto the predetermined conveyor belt so as to prevent consumption of the weight measuring device, thereby enhancing the lifetime of the weight measuring device.

Further benefits and advantages of the present invention will become apparent after a careful reading of the detailed description with appropriate reference to the accompanying drawings.

### BRIEF DESCRIPTION OF THE DRAWINGS

FIG. 1 is a plan cross-sectional view of a weight sorter in accordance with the preferred embodiment of the present invention;

FIG. 2 is a schematic operational view of the weight sorter as shown in FIG. 1 in use;

FIG. 3 is a plan cross-sectional view of a weight sorter in accordance with another embodiment of the present invention; and

FIG. 4 is a plan cross-sectional view of a weight sorter in accordance with another embodiment of the present invention.

### DETAILED DESCRIPTION OF THE INVENTION

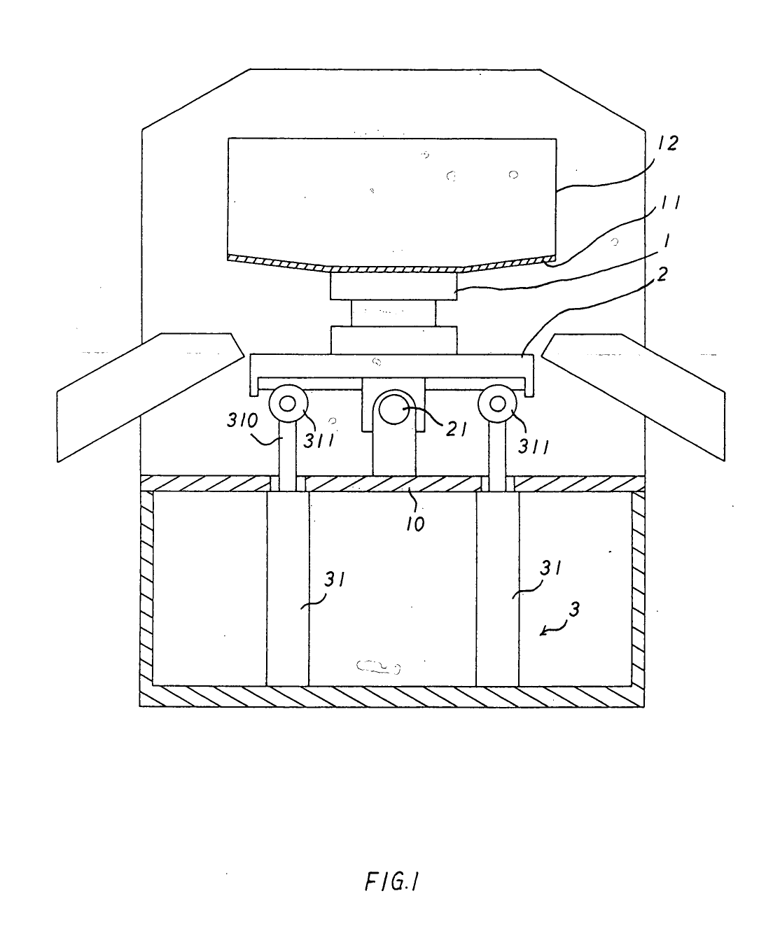

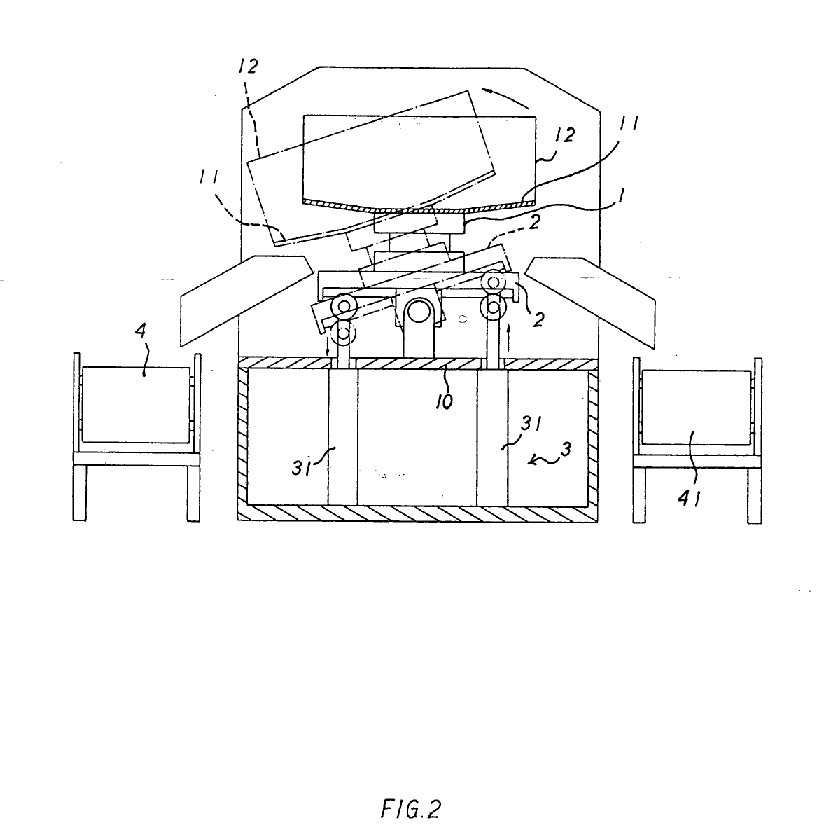

Referring to the drawings and initially to FIGS. 1 and 2, a weight sorter in accordance with the preferred embodiment of the present invention comprises a base 2, a weight measuring device 1 mounted on a top of the base 2 to measure a weight of an article 12, and a pivot device 3 mounted on a bottom of the base 2 and operable to pivot the base 2 when the weight measuring device 1 measures the weight of the article 12 so as to drop the article 12 onto a predetermined conveyor belt 4 or 41, thereby finishing a weight selection work. Preferably, the weight measuring device 1 sends a signal to control and operate the pivot device 3 to pivot the base 2 after the weight measuring device 1 measures the weight of the article 12.

In the preferred embodiment of the present invention, the weight measuring device 1 is fixed on the top of the base 2 to pivot therewith. The base 2 has a pivot shaft 21 pivotally mounted on a main frame 10. The pivot device 3 includes two hydraulic cylinders 31 each mounted on the main frame 10 and each having a retractable distal end 310 pivotally connected to one of two opposite sides of the base 2 by a roller 311. The hydraulic cylinders 31 of the pivot device 3 are operable to pivot the base 2 when the weight measuring device 1 measures the weight of the article 12. Thus, after the weight measuring device 1 measures the weight of the article 12, one of the hydraulic cylinders 31 is expanded and the other one of the hydraulic cylinders 31 is retracted, so that the base 2 is pivoted about the pivot shaft 21.

As shown in FIG. 1, the article 12 is supported by the weight measuring device 1 which is pivoted with the base 2. Thus, when the base 2 is pivoted by the pivot device 3 to move from the position as shown in FIG. 1 to the position as shown in FIG. 2, the weight measuring device 1 is located at an inclined state, so that the article 12 is also located at an inclined state and is dropped onto the conveyor belt 4. Alternatively, the pivot device 3 is operated reversely, so that the article 12 is dropped onto the other conveyor belt 41.

Thus, when the weight of the article 12 satisfies the predetermined standard of the weight measuring device 1, the pivot device 3 is operated normally, so that the article 12 is dropped onto the conveyor belt 4, and when the weight of the article 12 does not satisfy the predetermined standard of the weight measuring device 1, the pivot device 3 is operated reversely, so that the article 12 is dropped onto the other conveyor belt 41.

In the preferred embodiment of the present invention, after the weight measuring device 1 measures the weight of the article 12, the weight measuring device 1 stops operating until the pivot device 3 is restored to its original state after dropping the article 12 onto the predetermined conveyor belt 4 or 41.

As shown in FIG. 1, the article 12 is supported by a support tray 11 which is mounted on the weight measuring device 1 to pivot therewith. Preferably, the support tray 11 is formed with an inner arcuate concave recess to retain the article 12 during the pivot action.

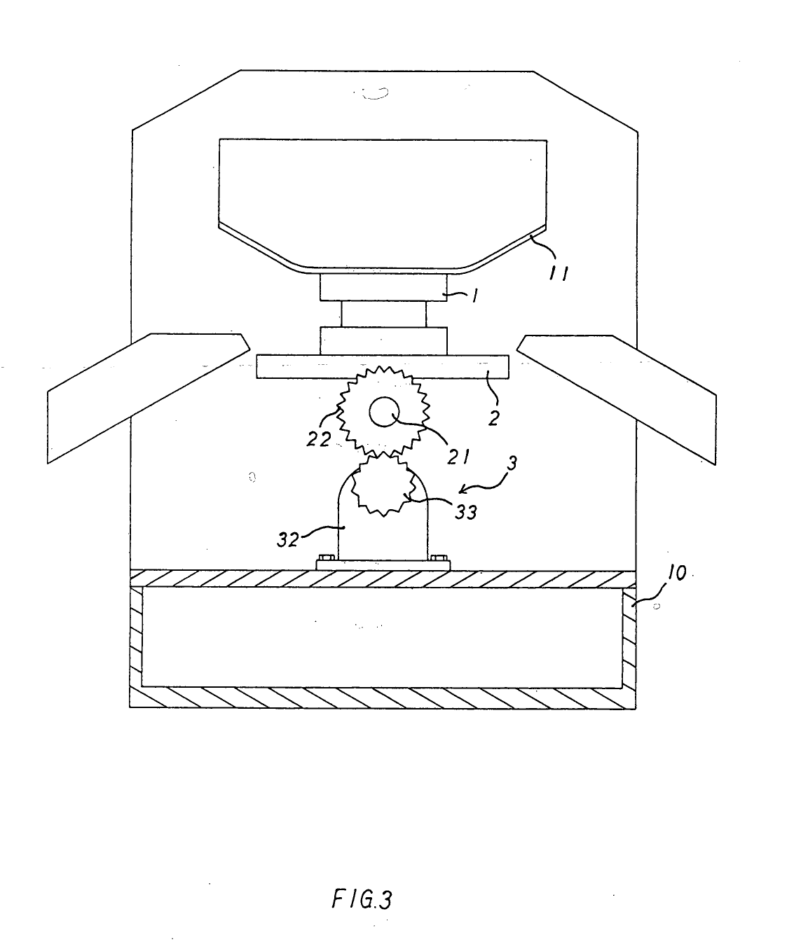

Referring to FIG. 3, in accordance with another embodiment of the present invention, the base 2 has a pivot shaft 21 provided with a driven gear 22, and the pivot device 3 includes a drive gear 33 meshing with the driven gear 22 to rotate the driven gear 22, and a motor 32 mounted on the main frame 10 and connected to the drive gear 33 to rotate the drive gear 33. The motor 32 is operable to pivot the base 2 when the weight measuring device 1 measures the weight of the article 12. Thus, after the weight measuring device 1 measures the weight of the article 12, the motor 32 drives and rotates the drive gear 33 which rotates the driven gear 22 which rotates the pivot shaft 21 which rotates the base 2, so that the base 2 is located at an inclined state.

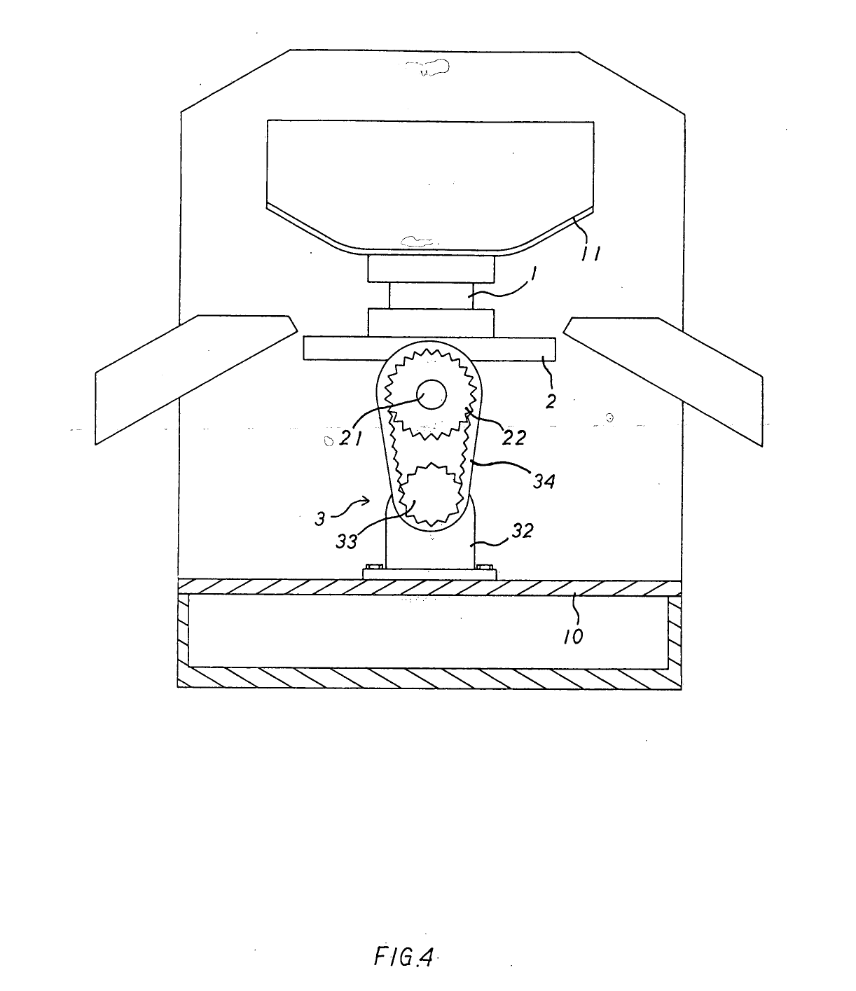

Referring to FIG. 4, in accordance with another embodiment of the present invention, the base 2 has a pivot shaft 21 provided with a driven gear 22, and the pivot device 3 includes a drive gear 33 rotatably mounted on the main frame 10, a toothed belt 34 mounted between the driven gear 22 and the drive gear 33 so that the driven gear 22 and the drive gear 33 are rotated synchronously, and a motor 32 mounted on the main frame 10 and connected to the drive gear 33 to rotate the drive gear 33. The motor 32 is operable to pivot the base 2 when the weight measuring device 1 measures the weight of the article 12. Thus, after the weight measuring device 1 measures the weight of the article 12, the motor 32 drives and rotates the drive gear 33 which rotates the toothed belt 34 which rotates the driven gear 22 which rotates the pivot shaft 21 which rotates the base 2, so that the base 2 is located at an inclined state.

Accordingly, the pivot device 3 does not apply any pressure or force on the weight measuring device 1 during the pivot action, so that the weight measuring device 1 is not subjected to an excessive force and can be used during a long-term utilization, thereby enhancing the lifetime of the weight measuring device 1. In addition, the ranges of the volume and weight of the article 12 are not limited by provision of the pivot device 3, thereby enhancing the versatility of the weight sorter. Further, after the weight measuring device 1 measures the weight of the article 12, the weight measuring device 1 stops operating until the pivot device 3 is restored to its original state after dropping the article 12 onto the predetermined conveyor belt 4 or 41 so as to prevent consumption of the weight measuring device 1, thereby enhancing the lifetime of the weight measuring device 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A weight sorter, comprising:
a base;
a weight measuring device mounted on a top of the base to measure a weight of an article;
a pivot device mounted on a bottom of the base and operable to pivot the base when the weight measuring device measures the weight of the article so as to drop the article onto a predetermined conveyor belt, thereby finishing a weight selection work.

2. The weight sorter in accordance with claim 1, wherein the weight measuring device sends a signal to control and operate the pivot device to pivot the base after the weight measuring device measures the weight of the article.

3. The weight sorter in accordance with claim 1, wherein the weight measuring device is fixed on the top of the base to pivot therewith.

4. The weight sorter in accordance with claim 1, wherein the base has a pivot shaft pivotally mounted on a main frame, and the pivot device includes two hydraulic cylinders each mounted on the main frame and each having a retractable distal end pivotally connected to one of two opposite sides of the base by a roller.

5. The weight sorter in accordance with claim 4, wherein the hydraulic cylinders of the pivot device are operable to pivot the base when the weight measuring device measures the weight of the article.

6. The weight sorter in accordance with claim 4, wherein after the weight measuring device measures the weight of the article, one of the hydraulic cylinders is expanded and the other one of the hydraulic cylinders is retracted, so that the base is pivoted about the pivot shaft.

7. The weight sorter in accordance with claim 1, wherein the article is supported by the weight measuring device which is pivoted with the base.

8. The weight sorter in accordance with claim 1, wherein after the weight measuring device measures the weight of the article, the weight measuring device stops operating until the pivot device is restored to its original state after dropping the article onto the predetermined conveyor belt.

9. The weight sorter in accordance with claim 1, wherein the article is supported by a support tray which is mounted on the weight measuring device to pivot therewith.

10. The weight sorter in accordance with claim 9, wherein the support tray is formed with an inner arcuate concave recess.

11. The weight sorter in accordance with claim 1, wherein the base has a pivot shaft provided with a driven gear, and the pivot device includes a drive gear meshing with the driven gear to rotate the driven gear, and a motor mounted on the main frame and connected to the drive gear to rotate the drive gear.

12. The weight sorter in accordance with claim 11, wherein the motor is operable to pivot the base when the weight measuring device measures the weight of the article.

13. The weight sorter in accordance with claim 11, wherein after the weight measuring device measures the weight of the article, the motor drives and rotates the drive gear which rotates the driven gear which rotates the pivot shaft which rotates the base, so that the base is located at an inclined state.

14. The weight sorter in accordance with claim 1, wherein the base has a pivot shaft provided with a driven gear, and the pivot device includes a drive gear rotatably mounted on the main frame, a toothed belt mounted between the driven gear and the drive gear so that the driven gear and the drive gear are rotated synchronously, and a motor mounted on the main frame and connected to the drive gear to rotate the drive gear.

15. The weight sorter in accordance with claim 14, wherein the motor is operable to pivot the base when the weight measuring device measures the weight of the article.

16. The weight sorter in accordance with claim 14, wherein after the weight measuring device measures the weight of the article, the motor drives and rotates the drive gear which rotates the toothed belt which rotates the driven gear which rotates the pivot shaft which rotates the base, so that the base is located at an inclined state.
